(19) United States
(12) Patent Application Publication
(10) Pub. No.: US 2016/0014397 A1
(43) Pub. Date: Jan. 14, 2016

(54) IMAGE CAPTURING APPARATUS AND CONTROL METHOD FOR THE SAME

(71) Applicant: CANON KABUSHIKI KAISHA, Tokyo (JP)

(72) Inventors: Ryuhei Konno, Yokohama-shi (JP); Koji Maeda, Kawasaki-shi (JP)

(21) Appl. No.: 14/793,154

(22) Filed: Jul. 7, 2015

(30) Foreign Application Priority Data
Jul. 9, 2014 (JP) 2014-141776
Jun. 26, 2015 (JP) 2015-128957

(51) Int. Cl. H04N 13/02; G06T 5/00; H04N 5/232; H04N 5/208; G02B 27/00; H04N 13/00; G06T 7/00

(52) U.S. Cl. CPC H04N 13/0296; H04N 13/021; H04N 13/0055; G06T 5/002; G06T 5/003; G06T 7/0069; H04N 5/208; G02B 27/0075; H04N 5/23212; H04N 5/2329; H04N 2013/0081; G06T 2207/10012; G06T 2207/10028; G06T 2207/10144; G06T 2207/10148; G06T 2207/20201; G06T 2207/20216; H04N 2201/02449

(57) ABSTRACT

An image capturing apparatus capable of obtaining a plurality of parallax images and a captured image obtained by performing additive compositing on the parallax images, the image capturing apparatus comprising: a setting unit configured to set a first aperture value; an image capturing unit configured to obtain a plurality of parallax images by means of imaging using a second aperture value smaller than the first aperture value; a first generation unit configured to generate a captured image by performing additive compositing on the parallax images; and a second generation unit configured to generate an image having a depth of field equivalent to that in a case of using the first aperture value, by means of refocus processing using the captured image generated by the first generation unit and the plurality of parallax images.

### BACKGROUND OF THE INVENTION

1. Field of the Invention

The present invention relates to an image capturing apparatus and a control method for the same, and in particular relates to a technique for compositing captured images.

2. Description of the Related Art

An image capturing apparatus such as a digital camera uses an image capture optical system constituted by an imaging lens or the like to guide an optical image from an object to an image sensor and obtain an electrical signal corresponding to the object image. Then, a captured image of the object is obtained by performing analog-to-digital (AD) conversion on the obtained electrical signal and performing developing processing.

A photographer adjusts the depth of field of the captured image by adjusting the size of an F-number (aperture ratio) of a diaphragm provided in the image capture optical system. By adjusting the F-number so as to adjust the in-focus range of the captured image, it is possible to reduce the depth of field, causing the object to stand out from the background and thus be emphasized, or to increase the depth of field so as to obtain a deep focus image. In order to increase the depth of field of the captured image, the F-number needs to be increased, and in order to maintain the appropriate exposure, the shutter speed needs to be slowed down or the sensitivity needs to be increased. However, slowing down the shutter speed leads to blurring caused by manual shaking and object blurring, and raising the sensitivity amplifies noise in the captured image.

On the other hand, a technique for increasing the depth of field of a captured image without increasing the F-number has been proposed (Japanese Patent Laid-Open No. 6-311411). Japanese Patent Laid-Open No. 6-311411 discloses a technique of compositing image regions of multiple images captured with different in-focus positions so as to output a composite image that is entirely in-focus.

Since the object of the technique disclosed in Japanese Patent Laid-Open No. 6-311411 is to obtain an image that is entirely in-focus, the photographer cannot adjust the depth of field to express what he or she wants to express. Also, since image capture is repeated while the in-focus position is changed, if an image with manual shaking or object blurring is included in the multiple captured images, the result of compositing will be influenced thereby.

### SUMMARY OF THE INVENTION

The present invention has been made in consideration of the aforementioned problems, and realizes a technique according to which a captured image with a depth of field larger than a depth of field obtained under set imaging conditions can be obtained in one instance of shooting.

In order to solve the aforementioned problems, the present invention provides an image capturing apparatus capable of obtaining a plurality of parallax images and a captured image obtained by performing additive compositing on the parallax images, the image capturing apparatus comprising: a setting unit configured to set a first aperture value; an image capturing unit configured to obtain a plurality of parallax images by means of imaging using a second aperture value smaller than the first aperture value; a first generation unit configured to generate a captured image by performing additive compositing on the parallax images; and a second generation unit configured to generate an image having a depth of field equivalent to that in a case of using the first aperture value, by means of refocus processing using the captured image generated by the first generation unit and the plurality of parallax images.

In order to solve the aforementioned problems, the present invention provides an image capturing apparatus capable of obtaining a plurality of parallax images and a captured image obtained by performing additive compositing on the parallax images, the image capturing apparatus comprising: an obtaining unit configured to obtain a first depth of field for a captured image, which corresponds to a set first aperture value; a determining unit configured to determine a second aperture value for obtaining an image with a second depth of field that is shallower than the first depth of field, the second aperture value being such that it is possible to generate an image equivalent to that with the first depth of field by performing refocus processing on parallax images obtained by means of imaging using the second aperture value; and an image capturing unit configured to obtain a plurality of parallax images and a captured image obtained by performing additive compositing on the plurality of parallax images, by means of imaging using the second aperture value determined by the determining unit.

In order to solve the aforementioned problems, the present invention provides an image capturing apparatus capable of obtaining a plurality of parallax images and a captured image obtained by performing additive compositing on the parallax images, the image capturing apparatus comprising: an obtaining unit configured to obtain a first depth of field for the captured image, which corresponds to a set first imaging condition; a calculation unit configured to calculate a range of depths of field that can be realized according to an image obtained from the corresponding parallax images of one or more second imaging conditions according to which a depth of field of the captured image is a second depth of field that is shallower than the first depth of field; an image capturing unit configured to obtain a plurality of parallax images by performing image capture using, among the second imaging conditions, an imaging condition according to which the first depth of field can be realized using the second depth of field and the range of depths of field; an image obtaining unit configured to obtain a captured image by performing additive compositing on the parallax images; a generation unit configured to, based on the plurality of parallax images obtained by the image capturing unit, generate an image having a depth of field that compensates for a difference between the second depth of field and the first depth of field; and a compositing unit configured to generate an image having the first depth of field by compositing the captured images obtained by the image obtaining unit and the image generated by the generation unit.

In order to solve the aforementioned problems, the present invention provides a control method for an image capturing apparatus capable of obtaining a plurality of parallax images and a captured image obtained by performing additive compositing on the parallax images, the control method comprising: a setting step of setting a first aperture value; an image capturing step of obtaining a plurality of parallax images by means of imaging using a second aperture value smaller than the first aperture value; a first generation step of generating a captured image by performing additive compositing on the parallax images; and a second generation step of generating an image having a depth of field equivalent to that in a case of using the first aperture value, by means of refocus processing using the captured image generated by the first generation unit and the plurality of parallax images.

According to the present invention, a captured image with a depth of field larger than a depth of field obtained under set imaging conditions can be obtained in one instance of shooting.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram showing an example of a functional configuration of a digital camera serving as an example of an image capturing apparatus according to an embodiment of the present invention.

FIG. 2A is a block diagram showing an example of a functional configuration of an image processing unit according to an embodiment, and FIG. 2B is a block diagram showing an example of a functional configuration of an image capture system control unit.

FIG. 3 is a flowchart showing a series of operations for imaging processing according to an embodiment.

FIG. 4 is a flowchart showing a series of operations for image processing according to an embodiment.

FIG. 5 is a diagram schematically showing a depth range for depths of field according to an embodiment.

### DESCRIPTION OF THE EMBODIMENTS

### First Embodiment

Hereinafter, exemplary embodiments of the present invention will be described in detail with reference to the drawings. Note that as an example of an image capturing apparatus, an example will be described hereinafter in which the present invention is applied to a digital camera including an image sensor that can obtain a multi-viewpoint image. However, in the context of the present invention, the image capturing apparatus is not limited to being a digital camera and can be applied to any electronic device including this kind of image sensor. Examples of these electronic devices may include mobile phones, game devices, tablet terminals, personal computers, watch-type or glasses-type information terminals, and the like.

Configuration of Digital Camera 100

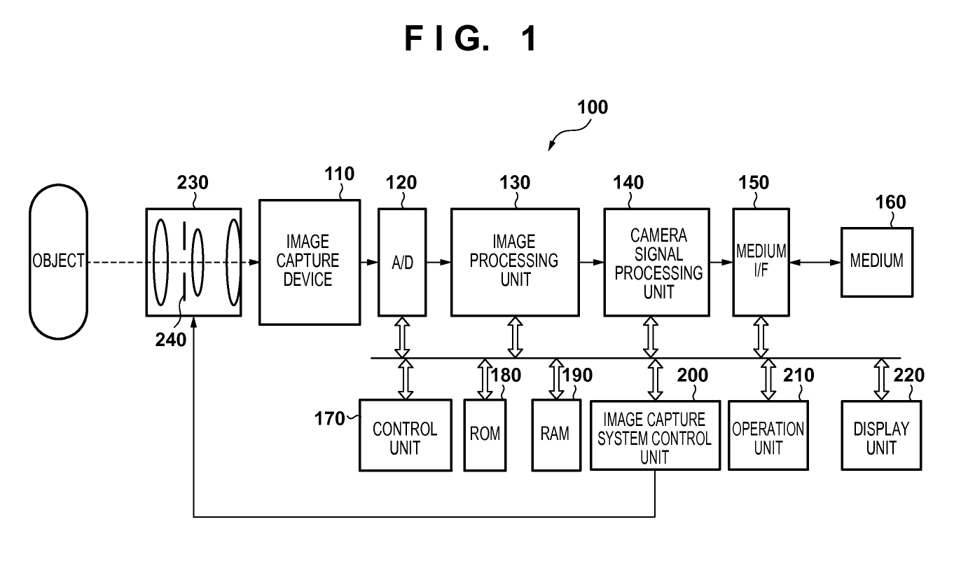

FIG. 1 is a block diagram showing an example of a functional configuration of a digital camera 100 as an example of an image capturing apparatus of the present embodiment. Note that one or more of the functional blocks shown in FIG. 1 may be realized by hardware such as an ASIC or a programmable logic array (PLA), or may be realized by a programmable processor such as a CPU or an MPU executing software. It may also be realized using a combination of software and hardware. Accordingly, in the description hereinafter, even in the case where different functional blocks are described as operating, the same hardware can be used for realizing the functional blocks.

An imaging lens 230 is included in an image capture optical system comprised of multiple groups of lenses, and includes in its interior a focus lens, a zoom lens, and a shift lens. The imaging lens 230 causes an object optical image to be formed on an image capture device 110.

An aperture 240 is included in the imaging lens 230 and the size of the aperture is controlled according to an instruction from an image capture system control unit 200.

An image capture device 110 includes an image sensor that converts an optical signal resulting from the formed object optical image into an electric signal and outputs it. The image sensor is a CMOS (Complementary Metal Oxide Semiconductor) image sensor, for example. Pixels, which are arranged in a two-dimensional shape, each have multiple photoelectric conversion regions, and the image sensor can obtain multiple parallax images with different viewpoints from the outputs of a group of photoelectric conversion regions at the same position in each pixel. Regarding the multiple parallax images, a captured image obtained using a normal image sensor in which each pixel has one photoelectric conversion region can be obtained by adding the outputs of multiple photoelectric conversion regions for each pixel. In the present embodiment, each pixel is constituted by two independent photoelectric conversion regions (photodiodes) A and B. Two parallax images A and B can be obtained by obtaining the outputs of the photoelectric conversion regions A and the outputs of the photoelectric conversion regions B as independent images. Also, a normal captured image can be obtained by, for each pixel, adding the outputs of the photoelectric conversion regions A and B. Note that regarding the captured image, an example will be described in which the captured image is obtained by performing additive compositing on multiple parallax images using a later-described image processing unit 130, for example, but the captured image may be obtained by performing additive compositing using the image capture device 110. Thus, the parallax images A and B and the captured image can be obtained in one instance of imaging (exposure). Note that in the description of the present embodiment, a case will be described in which two parallax images are obtained at the same time, but a configuration may be used in which luminous flux that is incident near the imaging plane is received by a larger number of pixels (e.g., 3×3 pixels), whereby a greater number of parallax images are obtained at the same time.

An A/D converter 120 uses an A/D conversion circuit to perform analog-to-digital conversion on an analog signal output output from the image capture device 110 and outputs digital signals (image data) in units of pixels.

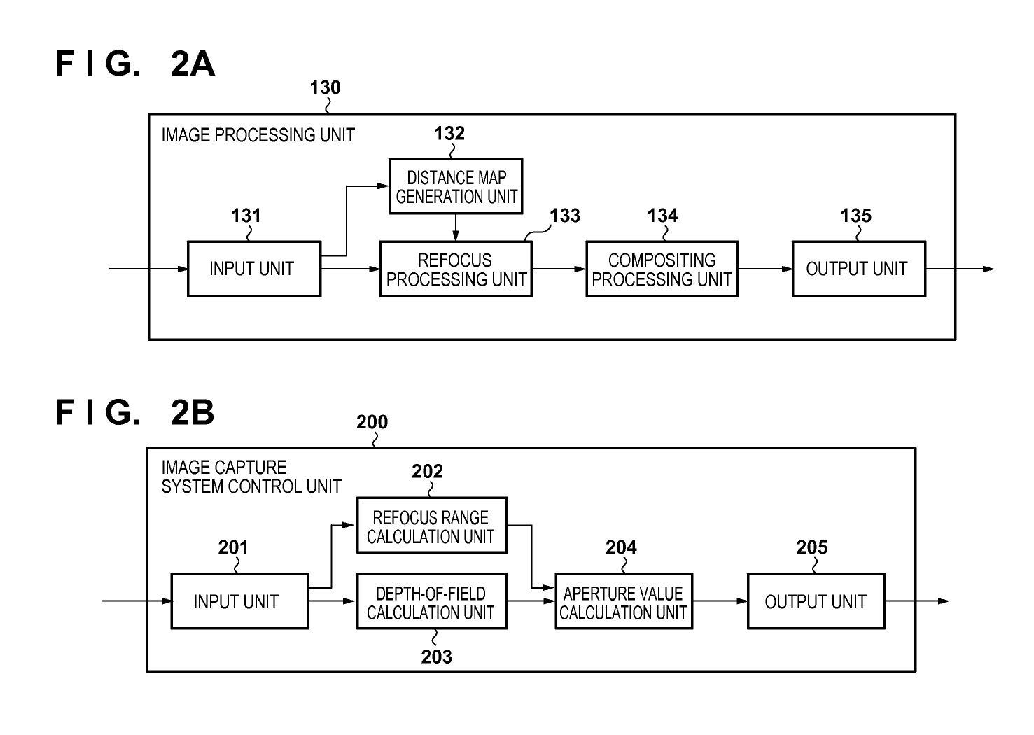

The image processing unit 130 performs predetermined color conversion processing and development processing such as tone correction on the image data output from the A/D converter 120 or the image data stored in a RAM 190. Also, the image processing unit 130 performs image processing for generating a refocus image using the two captured parallax images and the captured image that was generated. Note that refocusing is processing according to which it is possible to change the focus position and adjust the depth of field of an image using post-shooting image processing, and an image having a predetermined focus position and depth of field generated using refocusing will be referred to as a refocus image. FIG. 2A shows an example of a functional configuration of the image processing unit 130. An input unit 131 inputs two captured parallax images and generates a captured image by performing additive compositing on the parallax images, although the operations of the functional blocks will be described later. Then, the images are supplied to a distance map generation unit 132 and a refocus processing unit 133. The distance map generation unit 132 generates a distance map, which is information in the depth direction from the two input parallax images. The refocus processing unit 133 uses the captured image to generate an image having a depth of field that corresponds to a later-described refocus range. A compositing processing unit 134 composites the image generated by the refocus processing unit 133 and the captured image to generate a composite image having a depth of field intended by the user. The output unit 135 outputs the composite image to a medium I/F 150, which is a functional block of a later stage.

A camera signal processing unit 140 performs compression processing for storage and processing needed for performing display on a display unit 220 on the image output from the image processing unit 130.

The image data output from the A/D converter 120 is stored in the RAM 190 via the image processing unit 130 and the camera signal processing unit 140, or the data from the A/D converter 120 is stored in the RAM 190 directly via the camera signal processing unit 140.

The control unit 170 has a CPU or an MPU, for example, and performs overall control of the processing of the digital camera 100, including later-described image capture processing and image processing, by the CPU dispatching a program stored in the ROM 180 to a work area of the RAM 190 and executing it, for example.

The ROM 180 is a storage medium for storing programs and setting values for the digital camera 100, and is constituted by a semiconductor memory or the like.

The RAM 190 is a volatile storage medium that temporarily stores data of the control unit 170. Also, it is a memory for storing captured still images and moving images, and includes an amount of storage sufficient for storing a predetermined number of still images and moving images of a predetermined length of time. Accordingly, high-speed and high-capacity writing of images can be performed in the RAM 190 also in the case of successive shooting, in which multiple still images are shot in succession. Further, the control unit 170 can use the RAM 190 as a work area as well.

The image capture system control unit 200 controls the imaging lens 230 and the aperture 240 according to the instruction from the control unit 170 and the result of processing the input image data. FIG. 2B shows an example of a functional configuration of the interior of the image capture system control unit 200. The input unit 201 obtains later-described shooting setting information from the RAM 190. A depth-of-field calculation unit 203 is a calculation unit that calculates the depth of field desired by a user based on imaging setting information. Also, a refocus range calculation unit 202 and an aperture value calculation unit 204 respectively determine a later-described refocus range and an aperture value set for the imaging lens 230. An output unit 205 outputs the determined aperture value to control the aperture 240.

An operation unit 210 includes an operation member composed of a button such as a shutter button or a touch panel and notifies the control unit 170 when a user operation is detected. The control unit 170 is notified when an intermediate operation state (half-pressed state) of the shutter button is detected, and the control unit 170 controls processes for imaging via the image capture system control unit 200. For example, operations of the imaging lens 230, such as diaphragm driving processing, AF (autofocus) processing, AE (automatic exposure) processing, AWB (auto white balance) processing, EF (flash pre-emission) processing, and object distance measurement processing are started. If a state in which the shutter button is sufficiently pressed (fully-pressed state) is detected, a signal read out from the image capture device 110 is subjected to processing by the image processing unit 130 and the camera signal processing unit 140 and the image data is stored in the RAM 190. Furthermore, a medium I/F 150 writes the image data in a medium 160, which is a storage medium constituted by a memory card or the like.

The display unit 220 includes a display such as a TFT LCD and displays image data for display stored in the RAM 190 according to an instruction from the control unit 170. If the image data captured using the display unit 220 is displayed in sequence, a live view function can be realized.

Series of Operations Relating to Imaging Processing

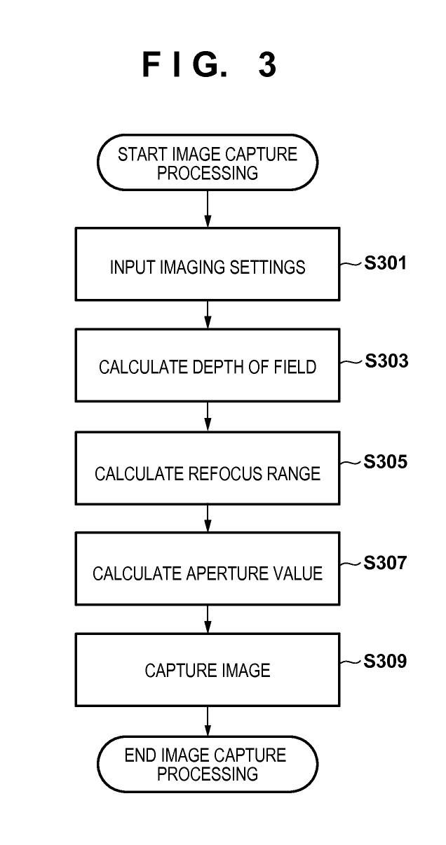

Next, a series of operations relating to imaging processing will be described with reference to FIG. 3. Note that the present processing is started when the fully-pressed state of the shutter button of the operation unit 210 is detected in a state in which live view display is performed in the digital camera 100.

In step S301, the input unit 201 inputs the imaging setting information set in the digital camera 100. The imaging setting information includes the size of the image sensor of the digital camera 100, the aperture value, the object distance, which is the distance from the imaging lens to the object, and the focal length, which is the distance from the imaging lens to the image sensor. Pieces of imaging setting information that have fixed values are stored in advance in the ROM 180, and the input unit 201 inputs the information from the ROM 180. The size of the image sensor is an example of a piece of information with a fixed value. Also, the aperture value and the focal length are dynamic values obtained by the user setting intended values via the operation unit 210, and for example, they are pieces of information stored by the control unit 170 in the RAM 190. Also, the object distance may be information obtained by storing, out of the distance map obtained using the parallax images obtained when live view display is being performed, the distance of a predetermined location in an image (e.g., the center of the image) as the object distance in the RAM 190, for example. The input unit 201 outputs the input shooting setting information to the refocus range calculation unit 202 and the depth-of-field calculation unit 203.

In step S303, the depth-of-field calculation unit 203 calculates the depth of field obtained by shooting, based on the imaging setting information output from the input unit 201. That is to say, the depth of field intended by the user (target depth of field), which corresponds to the aperture value (F-number) set by the user using the operation unit 210, is calculated. Specifically, letting the focus range from the object to the digital camera 100 be a near depth-of-field Dn, and the focus range from the object to an infinite distance be a far depth-of-field Df, the depth-of-field DOF can be expressed using Equation 1 below. Note that the near depth-of-field Dn can be expressed using Equation 2, the far depth-of-field Df can be expressed using Equation 3, and a hyperfocal length H (focal length at which the infinite distance falls within the depth of field), which is used in these equations, can be expressed using Equation 4. In the following equations, f represents the focal length of the lens, s represents the object distance, N represents the aperture value, and c represents the diameter of the circle of confusion.

$$\begin{matrix}[ Equation 1 ] & \\ D O F = {D}_{n} + {D}_{f} & ( eq . 1 ) \\ [ Equation 2 ] & \\ {D}_{n} = \frac{s ( H - f )}{H + s - 2 f} & ( eq . 2 ) \\ [ Equation 3 ] & \\ {D}_{f} = \frac{s ( H - f )}{H - s} & ( eq . 3 ) \\ [ Equation 4 ] & \\ H = \frac{{f}^{2}}{Nc} + f & ( eq . 4 )\end{matrix}$$

In step S305, the refocus range calculation unit 202 inputs the imaging setting information output from the input unit 201. For example, based on the pixel pitch obtained from the focal length and the size of the image sensor, the range in which refocusing is possible when shooting with an aperture value smaller than the current aperture value is calculated for one or more aperture values. Note that the range in which refocusing is possible, or in other words, the range of the depth of field that can be changed by refocusing is referred to as the refocus range. Since the angular distribution of light rays that are incident on the image sensor, or in other words, the parallax amount of the parallax images (shifting between images) is limited by the opening diameter according to the imaging lens 230 and the aperture 240, the pixel pitch in the image capture device 110, and the like, the range in which refocusing is possible is restricted as well. For this reason, the refocus range is calculated in advance and image capture processing is performed in consideration of the refocus range. Here, the refocus range can be obtained using a known method, such as the method disclosed in paragraphs 0027 to 0032 and 0046 of Japanese Patent Laid-Open No. 2013-258453. Thus, the refocus range calculation unit 202 calculates the refocus range according to the configurations of the imaging lens 230 and the image capture device 110 and the imaging conditions. Note that as described above, since it is possible to obtain a correspondence relationship between one or more possible aperture values and the refocus ranges that correspond thereto, a configuration is possible in which a set comprising the aperture values and refocus ranges that satisfy the conditions for realizing a target depth of field can be selectively determined in subsequent processing.

In step S307, the aperture value calculation unit 204 uses the target depth of field calculated in step S303 and the refocus range calculated in step S305 to determine the aperture value (imaging aperture value) to be used in subsequent imaging processing.

Specifically, the aperture value calculation unit 204 determines the imaging aperture value such that the target depth of field obtained using the aperture value set by the user can be realized using the depth of field of the captured image obtained using the imaging aperture value and the refocus range corresponding to the parallax images captured using the imaging aperture value. At this time, the depth of field of the captured image corresponding to the imaging aperture value may be calculated by the depth-of-field calculation unit 203 if necessary. Accordingly, a value smaller than the aperture value set by the user can be determined as the imaging aperture value, and an image having a target depth of field can be obtained with imaging conditions that are advantageous with respect to the occurrence of object blur and manual shaking, and an increase in image noise.

If multiple candidates for the above-described aperture value exist, the aperture value calculation unit 204 may use the following method to give priority to the aperture values and select one aperture value in accordance with the priority order. For example, the aperture values at which the contrast is preferable according to the optical characteristics of the lens are ordered and stored in advance, and among the multiple candidates for the aperture value, the aperture value at which the contrast is the most preferable is selected. Also, after eliminating specific aperture values at which diffraction can occur, the multiple candidates for the aperture value may be selected with priority from among aperture values at which diffraction does not occur. Similarly, an aperture value prioritized according to a set sensitivity region may be selected by ordering the aperture values at which the S/N ratio is preferable and storing them according to the sensitivity region that can be set in the digital camera 100. By doing so, in addition to being able to obtain a clearer image with a target depth of field, it is possible to obtain an image whose contrast is more preferable and an image whose S/N ratio is preferable. Also, a higher-quality image can be obtained without using an aperture value at which diffraction occurs when such an image is obtained.

In step S309, the control unit 170 performs image capture by controlling the aperture 240 based on the aperture value determined in step S307. The image capture device 110 reads out the two parallax images according to an instruction from the control unit 170. Upon causing the image processing unit 130 and the like to perform predetermined processing on the images, the control unit 170 stores the images resulting from the processing in the RAM 190. Thereafter, the control unit 170 ends the series of operations relating to image capture processing.

Series of Operations Relating to Image Processing

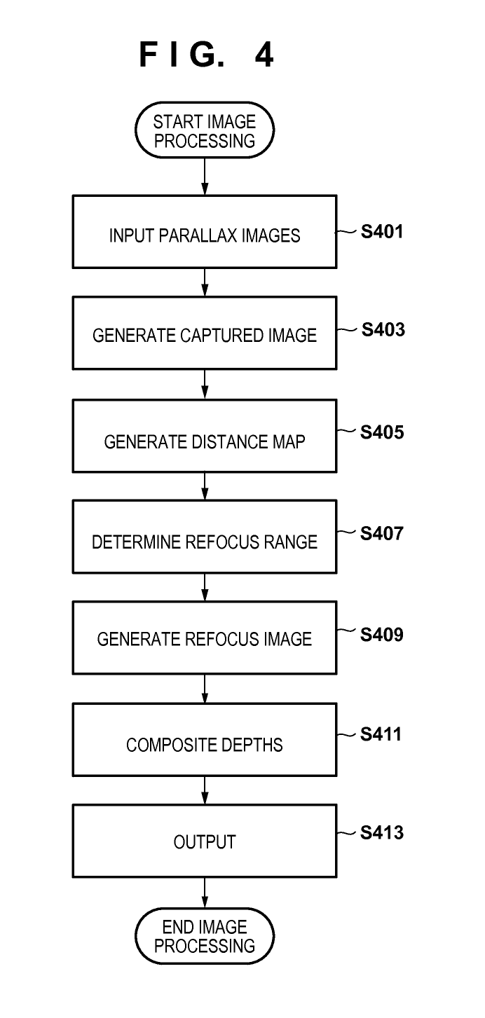

Next, a series of operations relating to image processing in the digital camera 100 according to the present embodiment will be described with reference to FIG. 4. Note that if the image capture processing of step S309 is executed and the captured images are stored in the RAM 190, the present processing is started.

In step S401 the input unit 131 of the image processing unit 130 inputs the two parallax images stored in the RAM 190 during image capture. Also, in step S403, the input unit 131 generates an image obtained by performing additive compositing on the two parallax images stored in the RAM 190 during image capture as the captured image.

In step S405, the distance map generation unit 132 generates a distance map, which is depth-of-field information of the captured image, from the parallax images obtained by the input unit 131 in step S401. Note that a known technique, such as SSDA (sequential similarity detection algorithm) or area correlation, can be used for the processing for generating the distance map from the parallax images having the parallaxes in the left-right direction, and therefore it is assumed that these techniques are used in the present embodiment, and thus detailed description thereof is not included. The distance map generation unit 132 stores the information on the generated distance map in the RAM 190.

In step S407, the refocus processing unit 133 determines the range of the depth of field that can be realized using the refocus image. The depth of field is a depth of field for enlarging the depth of field obtained using the aperture value determined in step S307 to the target depth of field calculated in step S303.

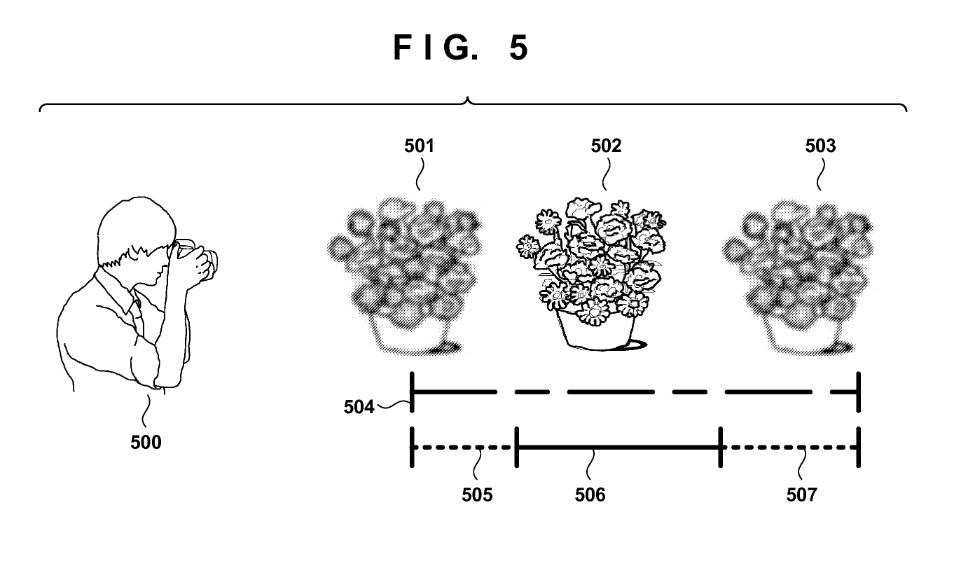

The relationship between the above-described depths of field will be described with reference to FIG. 5. Objects 501 to 503 are aligned such that they are separated from each other in the direction of infinity away from a photographer 500 who is the user of the digital camera 100. A target depth of field 504 indicates a depth range equivalent to the depth range obtained using the aperture value set by the user in the digital camera 100, or in other words, the target depth of field calculated in step S303. The depth of field 506 indicates the depth range obtained using the aperture value of the imaging lens 230 determined in step S307, or in other words, the depth of field of the image obtained by image capturing processing. As described above, the aperture value determined in step S307 is smaller than the aperture value set by the user, and therefore the depth of field 506 of the image obtained by image capturing processing is shallower than the target depth of field 504. Since the target depth of field 504 and the depth of field 506 are known, the refocus processing unit 133 determines the depth of field 505 and the depth of field 507, which are the differences between the target depth of field 504 and the depth of field 506, as the depth of field to be realized in the refocus image.

In step S409, the refocus processing unit 133 generates the refocus image that realizes the depth of field determined in step S407. For example, the refocus processing unit 133 generates a first refocus image in which the near end of the depth of field 505 is used as the object distance (or focal position) and a second refocus image in which the far end of the depth of field 507 is used as the object distance (or focal position). If the depth of field 505 cannot be realized in the first refocus image, a refocus image may be furthermore generated by changing the object distance in the depth of field 505 in the infinity direction. Regarding the depth of field 507 as well, the refocus image may be furthermore generated by changing the object distance in the depth of field 507 in the near direction as needed. Since it is possible to use a known method as the method for generating the image in which the object distance (or focal position) has been changed from that of the parallax images, detailed description thereof will not be included in the present embodiment.

In step S411, the compositing processing unit 134 generates an image having the target depth of field 504 by compositing the captured image generated in step S403 (i.e., the image having the depth of field 506), and the two refocus images generated in step S409. With the compositing of the images, it is sufficient that the image with the highest contrast in each predetermined square region of the image, for example, is selected and used as the pixels of the square region. Also, if the contrasts of all of the images are less than or equal to a predetermined threshold value, or in other words, for blurred regions outside of the range of the depth of field intended by the user, it is sufficient that the pixels of the captured image are used as-is. The compositing processing unit 134 stores the completed image that was generated in the RAM 190 and ends the series of operations for image processing.

Note that in the present embodiment, compositing of the captured image was performed in step S409 by generating a first refocus image and a second refocus image, but it is possible to use the obtained parallax images to generate one refocus image having the depths of field 505 to 507. With the processing for compositing the refocus image and the captured image, regarding a square region in which the contrasts of both the captured image and the refocus image are high, it is sufficient that the pixels of the captured image are selected with priority in order to use those pixels.

As described above, in the present embodiment, the depth of field desired by the user was realized using the depth of field of the captured image and the depths of fields that can be realized in refocus images obtained from parallax images that constitute the captured image. For this reason, imaging can be performed using an aperture value that is smaller than the aperture value for realizing the depth of field desired by the user using only the captured image. In other words, a captured image with a depth of field that is larger than a depth of field obtained using set imaging conditions can be obtained in one instance of imaging. For this reason, it is possible to obtain a captured image with a depth of field desired by the user while suppressing a reduction in image quality caused by the shutter speed decreasing or the sensitivity being raised in order to obtain the depth of field. Also, since the captured image and parallax images are obtained in one instance of imaging processing, problems caused by movement of the object, which can occur in a configuration in which images captured at different timings are composited, do not occur.

Also, if multiple candidates for selectable aperture values are present when the aperture value for performing imaging is to be determined, one aperture value is selected by prioritizing the aperture values based on information stored in advance. By doing so, an image can be generated that is more appropriate for the optical characteristics of the lens and the set sensitivity region.

### OTHER EMBODIMENTS

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2014-141776, filed Jul. 9, 2014 and 2015-128957, filed Jun. 26, 2015, which are hereby incorporated by reference herein in their entirety.

What is claimed is:

1. An image capturing apparatus capable of obtaining a plurality of parallax images and a captured image obtained by performing additive compositing on the parallax images, the image capturing apparatus comprising:
a setting unit configured to set a first aperture value;
an image capturing unit configured to obtain a plurality of parallax images by means of imaging using a second aperture value smaller than the first aperture value;
a first generation unit configured to generate a captured image by performing additive compositing on the parallax images; and
a second generation unit configured to generate an image having a depth of field equivalent to that in a case of using the first aperture value, by means of refocus processing using the captured image generated by the first generation unit and the plurality of parallax images.

2. The apparatus according to claim 1, wherein
the second generation unit performs refocus processing for generating an image having a depth of field that compensates for a difference between a depth of field corresponding to the second aperture value and the depth of field equivalent to that in the case of using the first aperture value.

3. An image capturing apparatus capable of obtaining a plurality of parallax images and a captured image obtained by performing additive compositing on the parallax images, the image capturing apparatus comprising:
an obtaining unit configured to obtain a first depth of field for a captured image, which corresponds to a set first aperture value;
a determining unit configured to determine a second aperture value for obtaining an image with a second depth of field that is shallower than the first depth of field, the second aperture value being such that it is possible to generate an image equivalent to that with the first depth of field by performing refocus processing on parallax images obtained by means of imaging using the second aperture value; and
an image capturing unit configured to obtain a plurality of parallax images and a captured image obtained by performing additive compositing on the plurality of parallax images, by means of imaging using the second aperture value determined by the determining unit.

4. The apparatus according to claim 1, wherein
the image capturing unit obtains the plurality of parallax images by using an image sensor in which each pixel has a plurality of independent photoelectric conversion regions, and
the first generation unit generates the captured image obtained by performing additive compositing on the parallax images.

5. An image capturing apparatus capable of obtaining a plurality of parallax images and a captured image obtained by performing additive compositing on the parallax images, the image capturing apparatus comprising:
an obtaining unit configured to obtain a first depth of field for the captured image, which corresponds to a set first imaging condition;
a calculation unit configured to calculate a range of depths of field that can be realized according to an image obtained from the corresponding parallax images of one or more second imaging conditions according to which a depth of field of the captured image is a second depth of field that is shallower than the first depth of field;
an image capturing unit configured to obtain a plurality of parallax images by performing image capture using, among the second imaging conditions, an imaging condition according to which the first depth of field can be realized using the second depth of field and the range of depths of field;
an image obtaining unit configured to obtain a captured image by performing additive compositing on the parallax images;
a generation unit configured to, based on the plurality of parallax images obtained by the image capturing unit, generate an image having a depth of field that compensates for a difference between the second depth of field and the first depth of field; and
a compositing unit configured to generate an image having the first depth of field by compositing the captured images obtained by the image obtaining unit and the image generated by the generation unit.

6. The apparatus according to claim 5, further comprising:
a determining unit configured to determine an aperture value according to which the first depth of field can be realized according to the second depth of field and the range of depths of field among the second imaging conditions,
wherein the image capturing unit performs image capture using the aperture value.

7. The apparatus according to claim 6, wherein
if there are a plurality of aperture values according to which the first depth of field can be realized, the determining unit determines the aperture value in accordance with a pre-determined order.

8. The apparatus according to claim 7, wherein
the pre-determined order is determined according to optical characteristics of the image capturing apparatus, or according to a sensitivity region that can be set in the image capturing apparatus.

9. The apparatus according to claim 7, wherein
among the plurality of aperture values according to which the first depth of field can be achieved, aperture values at which diffraction occurs are eliminated, and the aperture value is determined.

10. The apparatus according to claim 5, wherein
based on the configuration of pixels of the image sensor included in the image capturing apparatus, the calculation unit calculates the range of depths of field that can be achieved.

11. The apparatus according to claim 5, wherein
the generation unit generates a plurality of images having a depth of field that compensates for the difference between the second depth of field and the first depth of field, and
the compositing unit composites the captured image and the plurality of images generated by the generation unit.

12. The apparatus according to claim 5, wherein
the image capturing unit obtains the plurality of parallax images by using an image sensor in which each pixel has a plurality of independent photoelectric conversion regions.

13. The apparatus according to claim 12, wherein
the image obtaining unit obtains the captured image by adding outputs of the plurality of photoelectric conversion regions for each pixel.

14. A control method for an image capturing apparatus capable of obtaining a plurality of parallax images and a captured image obtained by performing additive compositing on the parallax images, the control method comprising:
a setting step of setting a first aperture value;
an image capturing step of obtaining a plurality of parallax images by means of imaging using a second aperture value smaller than the first aperture value;
a first generation step of generating a captured image by performing additive compositing on the parallax images; and
a second generation step of generating an image having a depth of field equivalent to that in a case of using the first aperture value, by means of refocus processing using the captured image generated by the first generation unit and the plurality of parallax images.
